(19) United States
(12) Patent Application Publication
(10) Pub. No.: US 2008/0102921 A1
(43) Pub. Date: May 1, 2008

(54) Wagering game with a guaranteed win feature

(76) Inventor: Daniel Urquhart, Moncton (CA)

Correspondence Address: KENYON & KENYON LLP, ONE BROADWAY, NEW YORK, NY, 10004, US

(21) Appl. No.: 11/588,663

(22) Filed: Oct. 26, 2006

(51) Int. Cl. A63F 13/00

(52) U.S. Cl. 463/20

(57) ABSTRACT

A game of chance may be provided to a player. A system to provide the game of chance may include a display configured to sequentially display a set of elements and at least one set of bonus elements, each set simulating slot machine reels. The system may also include an input device configured to receive a player indication of desire to play the game. The system may also include a processor configured to, responsive to the player indication, determine the set of elements based on pre-defined rules, award at least one winning bonus spin to the player if the set of elements are in a first pre-defined winning pattern, determine at least one set of bonus elements to the player, including a subset of winning sets of bonus elements, wherein a quantity of winning sets of bonus elements is equal to a quantity of winning bonus spins awarded to the player. The system may also include a dispenser for dispensing an award to the player, wherein the award is determined based on the subset of winning sets of bonus elements.

### BACKGROUND

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

A slot machine is a type of wagering game, often offered in casinos or other locations in jurisdictions with legal gambling. Traditional slot machines are coin-operated machines with three or more reels, each reel including a plurality of symbols. The reels spin when a lever on the side of the machine is pulled. The machine accepts a wager from a player and spins the reels. The machine typically pays out a prize based on a pattern of symbols depicted on the reels visible on the front of the machine when the reels stop.

A video slot machine replaces the reels with a video display, such as a CRT or LCD display. The display simulates the reels of a traditional slot machine by displaying a plurality of elements. Each element may depict a symbol and the elements may be animated to simulate spinning reels after a lever on the side of the machine is pulled.

A bonus is a special feature of some slot machines, and is activated when certain symbols appear in a pre-defined bonus combination. When the pre-defined bonus combination occurs at the slot machine, a bonus may be awarded. For example, the player may be presented with several items on a screen from which to choose. As the player chooses items, a quantity of credits is revealed and awarded. Another bonus may use a mechanical device, such as a spinning wheel, that works in conjunction with the bonus to display the amount won. Other bonuses include free spins or other extended play features.

A video gaming machine is an automated kiosk or terminal with an input and an output configured to provide a video game to a player. The video gaming machine is in communication with a server over a network. The video gaming machine may be configured to provide wagering games to the player and allows the player to bet on the outcome of a video game. Wagering games may include video slots, video poker, video keno, video lottery, or other conventional wagering games.

Video keno is similar to a conventional keno game, but configured to be provided over a video gaming machine to a single player. Conventional keno is a lottery-like or bingo-like gambling game played at casinos and bingo halls. A player chooses anywhere from 1 to 20 player numbers and marks them on a keno ticket of 80 numbers (1 to 80). The casino then draws 20 winning numbers at random. The player is awarded a prize based on his wager and how many player numbers match the winning numbers. Video keno allows the player to choose a set of player numbers from a virtual keno ticket of 80 numbers displayed at the video keno machine. The video keno machine then picks 20 winning numbers at random, and the player wins a prize based on how many player numbers match the winning numbers.

### BRIEF DESCRIPTION OF THE DRAWINGS

FIG. 1A illustrates an example screen shot of a pre-defined pattern triggering a bonus game, in accordance with an example embodiment of the present invention.

FIG. 1B illustrates an example screen shot of a transition screen before a bonus game, in accordance with an example embodiment of the present invention.

FIG. 1C illustrates an example screen shot of a bonus game, in accordance with an example embodiment of the present invention.

FIG. 1D illustrates an example screen shot of a bonus game winning spin, in accordance with an example embodiment of the present invention.

FIG. 1E illustrates an example screen shot of a bonus game non-winning spin, in accordance with an example embodiment of the present invention.

FIG. 1F illustrates an example screen shot of a transition screen after a bonus game, in accordance with an example embodiment of the present invention.

FIG. 2A illustrates an example screen shot of a video keno wagering game, in accordance with an example embodiment of the present invention.

FIG. 2B illustrates an example screen shot of a bonus game within a video keno wagering game, in accordance with an example embodiment of the present invention.

FIG. 3 illustrates a first example procedure for providing a wagering game, in accordance with an example embodiment of the present invention.

FIG. 4 illustrates a second example procedure for providing a wagering game, in accordance with an example embodiment of the present invention.

FIG. 5 illustrates an example procedure for providing a video keno wagering game, in accordance with an example embodiment of the present invention.

FIG. 6 illustrates an example video gaming machine, in accordance with an example embodiment of the present invention.

FIG. 7 illustrates an example system for providing a wagering game, in accordance with an example embodiment of the present invention.

FIG. 8A illustrates an example pay structure, in accordance with an example embodiment of the present invention.

FIG. 8B illustrates an example pay line structure, in accordance with an example embodiment of the present invention.

### DETAILED DESCRIPTION OF EXAMPLE EMBODIMENTS

Some example embodiments are generally related to video slot machines that simulate the reels of conventional slots machines on a video display. A video slot machine system and method for facilitating the play of games at such video slot machines may be provided which includes a guaranteed winning spin, for example, as a bonus prize in a video slot machine game. The game machine may provide for a bonus game when a pre-defined bonus winning combination of elements are displayed, wherein the bonus game includes a guaranteed quantity of winning bonus spins. The game machine may transition into the bonus game and provide bonus spins. Each bonus spin may be a winning bonus spin or a non-winning bonus spin. The game may continue to provide bonus spins until the player receives a pre-defined quantity of winning bonus spins, wherein the quantity may be pre-defined when the guaranteed winning spins are awarded. Similar guaranteed winning bonus rounds may also be provided for other wagering games, such as video keno.

Another example embodiment of the present invention may be a system for facilitating play of a game of chance. The system may include an input device configured to receive a player indication of a desire to play the game, a display configured to display a set of game elements simulating slot machine reels responsive to the player indication, and display a bonus game display responsive to a pre-defined bonus condition in the set of game elements, the bonus game comprising a series of bonus game plays that are provided until a predetermined quantity of bonus game play wins have occurred in the bonus game, and a processor in communication with the input device and the display, the processor configured to determine the set of game elements based on pre-defined rules responsive to the player indication, and determine the series of bonus game plays that are provided responsive to the occurrence of the pre-defined bonus condition in the set of game elements, the series of bonus games being provided until the predetermined quantity of bonus game wins occurs in the bonus game play. The system may also include a dispenser for dispensing a prize to the player, the prize based at least in part on the series of bonus game plays. The system may also include a prize structure, the prize structure mapping a pre-defined winning pattern to the prize associated with the pre-defined winning pattern. The prize may be determined by multiplying the prize by a bonus multiplier. The system may also include a payment receiving device to receive a payment from the player prior to the display displaying the set of game elements, the payment receiving device communicating to the processor that payment has been received. The bonus game plays may be simulated slot machine reel spins. The individual bonus game plays may be not guaranteed wins. The processor may be configured to determine the predetermined quantity of bonus game wins based on the pre-defined bonus condition. The display may be configured to signal the player the predetermined quantity of bonus game wins that have been awarded. The display may be further configured to display a transition screen before displaying the bonus game display. The system may also include a network interface in communication with a server over a network.

Another example embodiment of the present invention may be a method for facilitating play of a game of chance, including responsive to a player indication of a desire to play the game, displaying a set of game elements to the player, wherein the set of game elements simulate slot machine reels, and responsive to an occurrence of a pre-defined trigger condition, providing a bonus game to the player, the bonus game comprising a series of bonus game plays that are provided until at least a pre-defined quantity of bonus game wins have occurred. The pre-defined trigger condition may be a pre-defined winning pattern in the set of game elements. The bonus game plays may be simulated slot machine reel spins. The individual bonus game plays may be not guaranteed to win. The pre-defined quantity of bonus game wins may be based on the pre-defined trigger condition. The method may also include, responsive to the completion of the pre-defined quantity of bonus game wins, returning to a normal game play. The method may also include awarding a bonus prize to the player for each bonus game win, wherein each bonus prize is determined by looking up a prize structure and determining the bonus prize corresponding to the bonus game win. The method may also include receiving a wager amount from the player, wherein the bonus award is further determined in part based on the wager amount.

Another example embodiment of the present invention may be a method for facilitating play of a game of chance. The method may include responsive to a player indication of a desire to play the game, displaying a set of game elements to the player, wherein the set of game elements simulate slot machine reels, awarding a quantity of winning bonus spin to the player if the set of game elements are in a first pre-defined winning pattern, sequentially displaying at least one set of bonus elements to the player, including a subset of winning sets of bonus elements wherein a quantity of winning sets of bonus elements is equal to the quantity of winning bonus spins awarded, and awarding a prize associated with the winning sets of bonus elements. The sets of bonus elements may be not equal to the subset of winning sets of bonus elements. The prize associated with each winning set of bonus elements may be determined by looking up a prize structure. The prize may be determined by multiplying an award by a bonus multiplier. The method may also include displaying a total amount of prizes awarded while displaying the quantity of sets of bonus elements. The method may also include displaying a transition screen after the bonus spins are awarded. The method may also include receiving a wager amount from the player, wherein the prize is further determined in part based on the wager amount.

Another example embodiment of the present invention may be a method for facilitating play of a game of chance. The method may include responsive to a player indication of a desire to play the game, displaying a set of game elements to the player, and responsive to an occurrence of a pre-defined trigger condition, providing a bonus game to the player, the bonus game comprising a series of bonus game plays that are provided until at least a pre-defined quantity of bonus game wins have occurred. The game of chance may be a video keno game. The game of chance may be a video poker game. The game of chance may be a video roulette game. The game of chance may be a video slot machine game. The pre-defined trigger condition may be a pre-defined number of player-selected spots matching a second pre-defined number of winning spots. The method may also include receiving player-selected elements in the game of chance. The method may also include awarding a bonus prize to the player responsive to providing the pre-defined quantity of bonus game wins. The method may also include awarding a regular prize to the player responsive to the set of game elements.

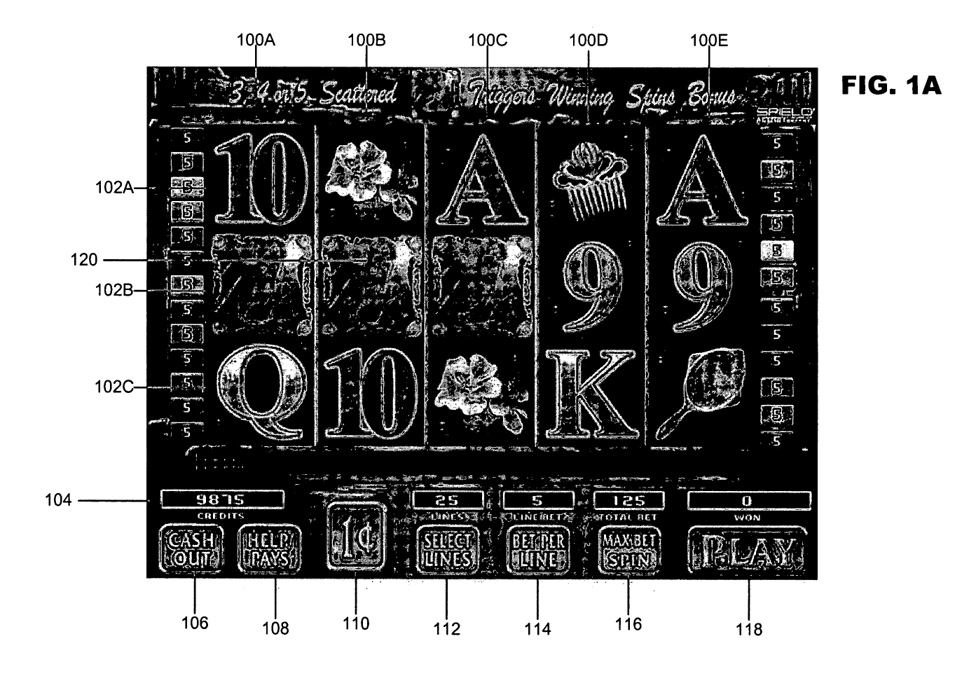

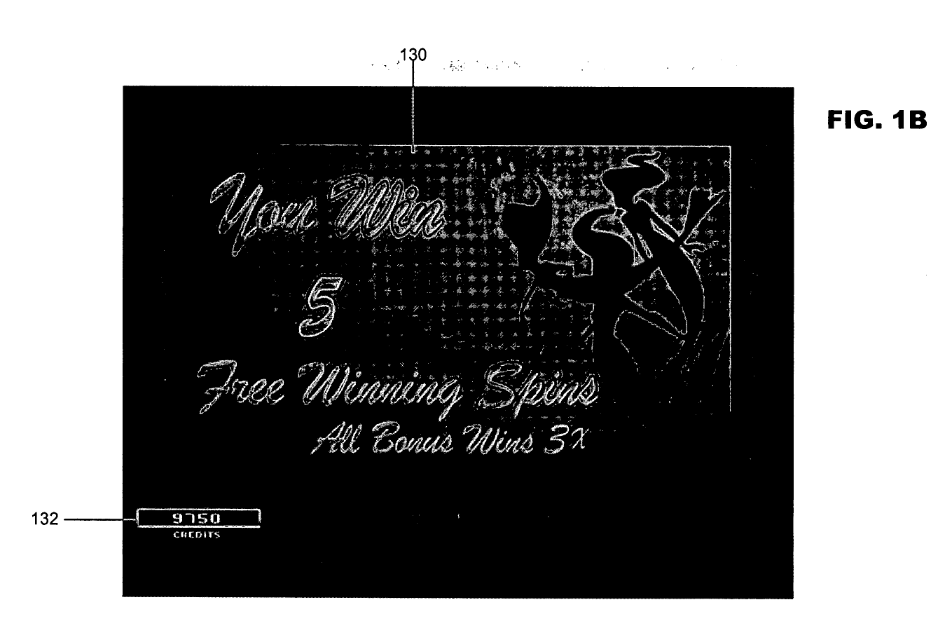

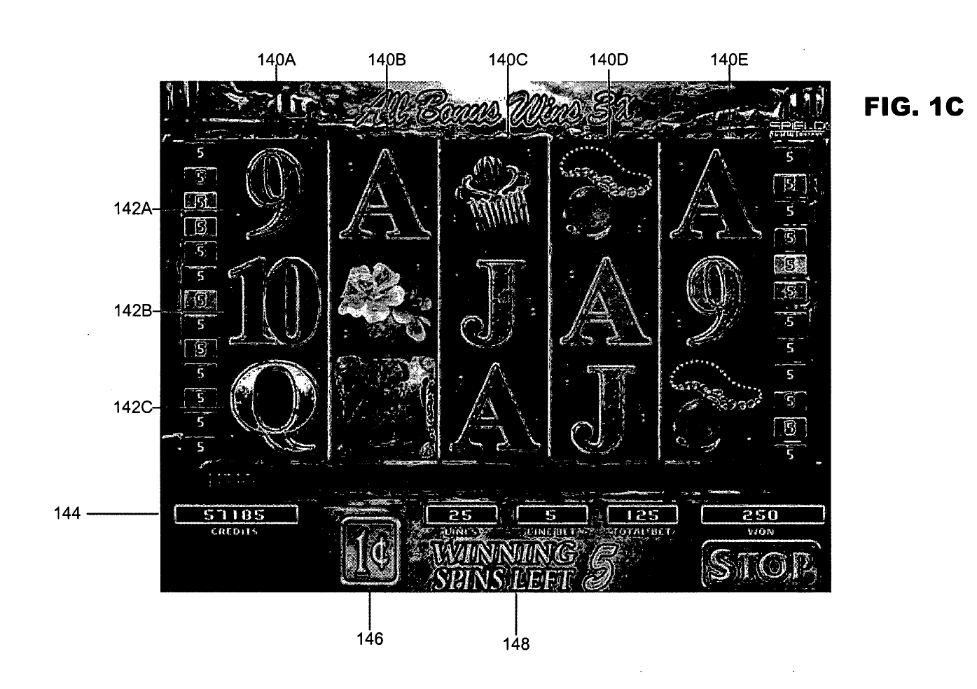

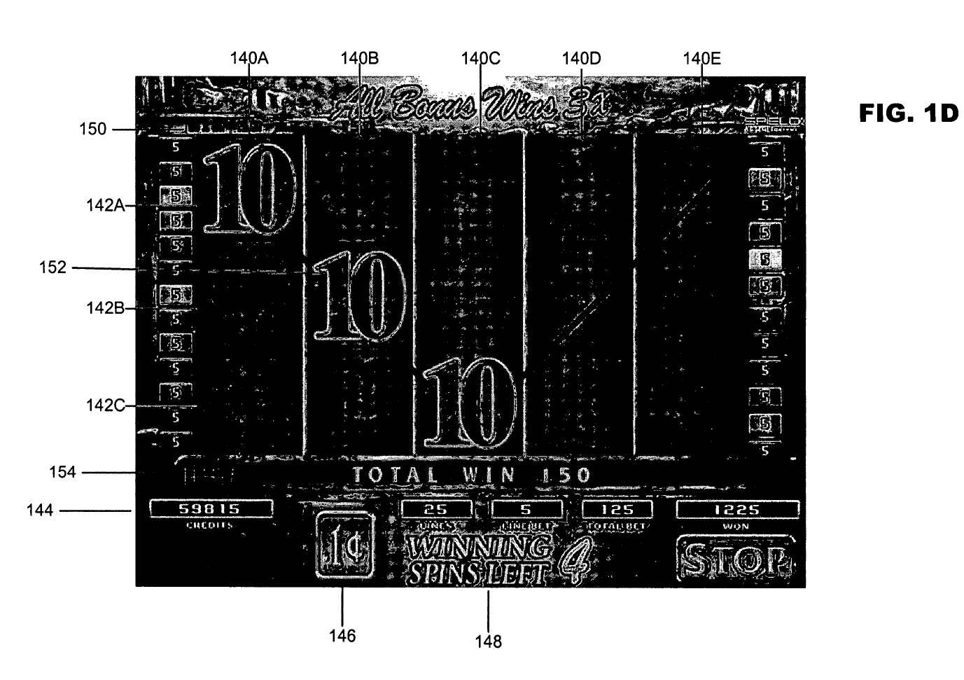

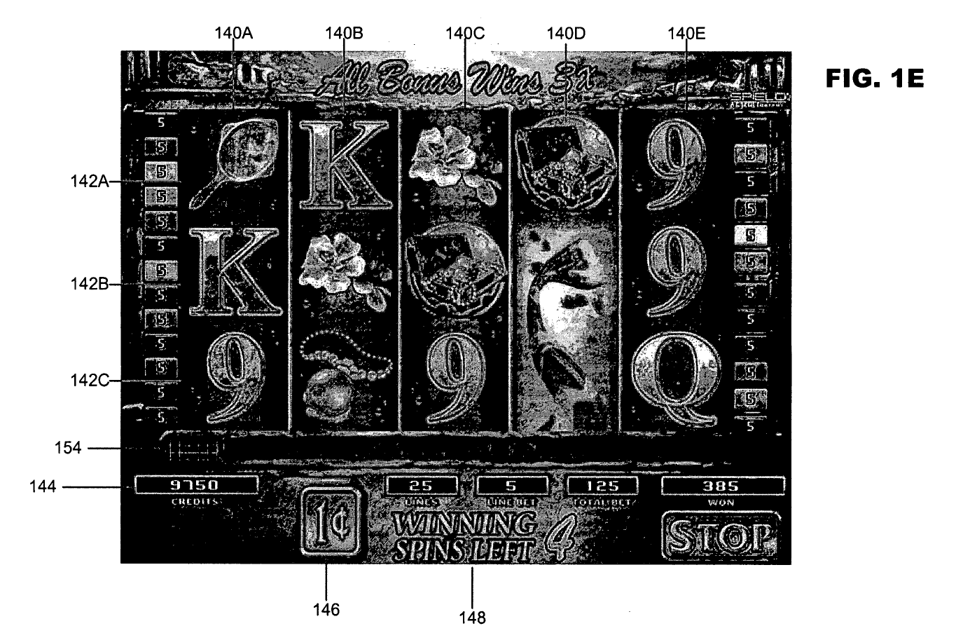

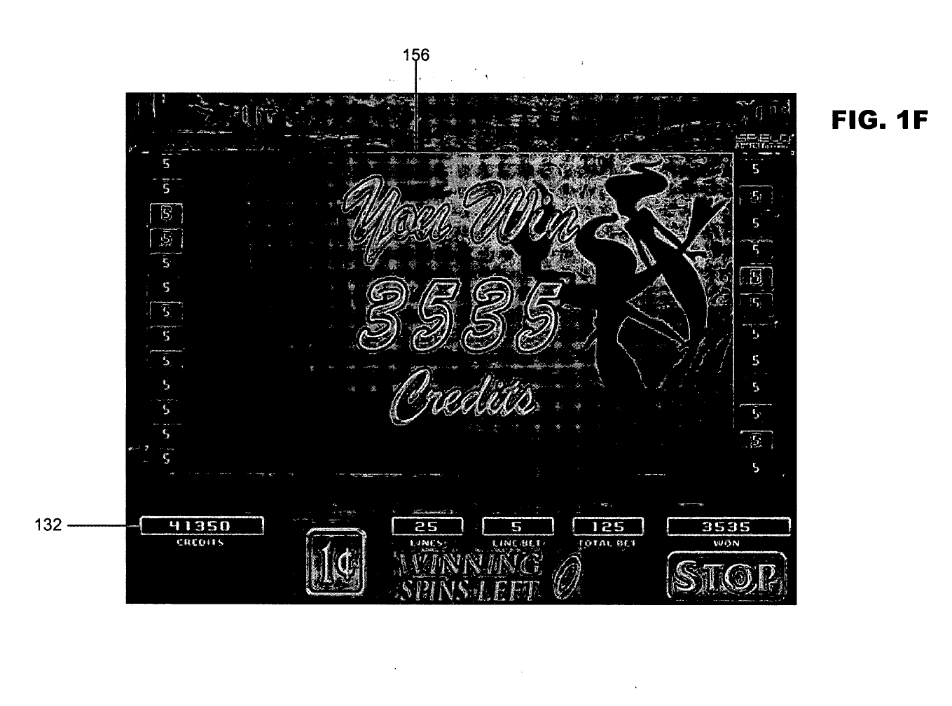

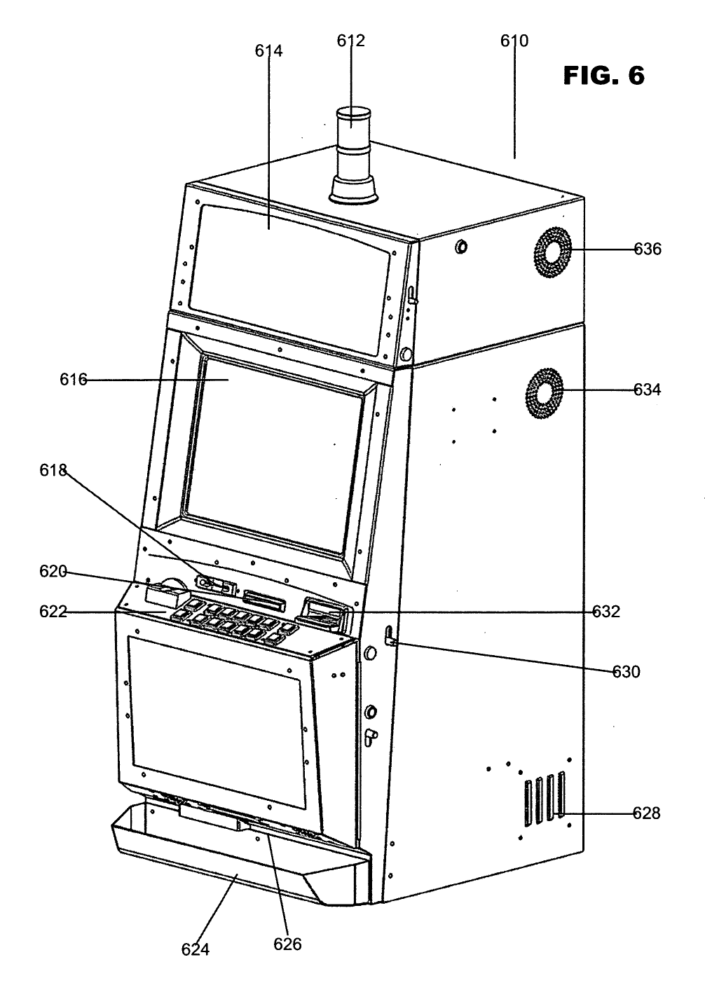

FIG. 1A illustrates an example screen shot of a pre-defined pattern triggering a bonus game, in accordance with an example embodiment of the present invention. The screen shot may be displayed on a monitor display of a video gaming machine (VGM) as depicted in FIG. 6. The VGM may be configured to provide a video slot game as described in the following figures. The video slot game may be provided to a player, who selects a wager and the VGM determines an outcome, either winning or losing. A winning outcome may be an award of a winning spin bonus, as described in this and the following figures. It will be appreciated that other types of bonus games may be provided, for example, roulette or other simulated casino games, simulated races, simulated card games, etc. The bonus may be player-triggered or automated by the game.

The video slot game may include a plurality of elements, each element displaying a symbol. The elements may be arranged into columns and rows. For example, the video slot game may include columns 100A, 100B, 100C, 100D, and 100E. The video slot game may include rows 102A, 102B, and 102C. Each element may be associated with a column and a row within the displayed elements.

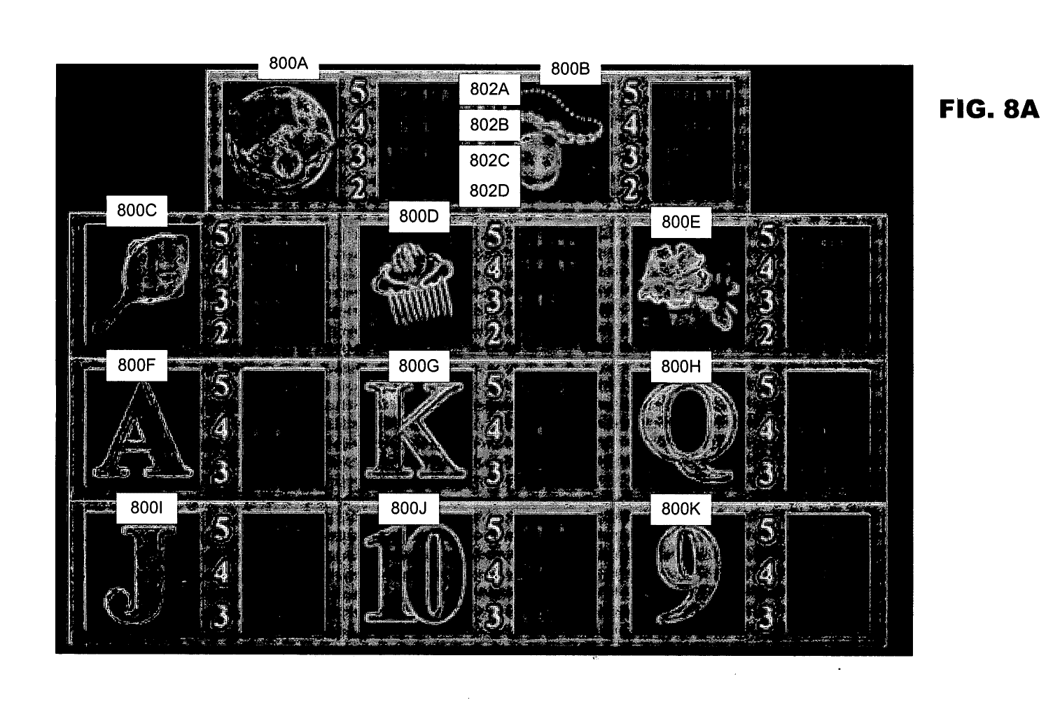

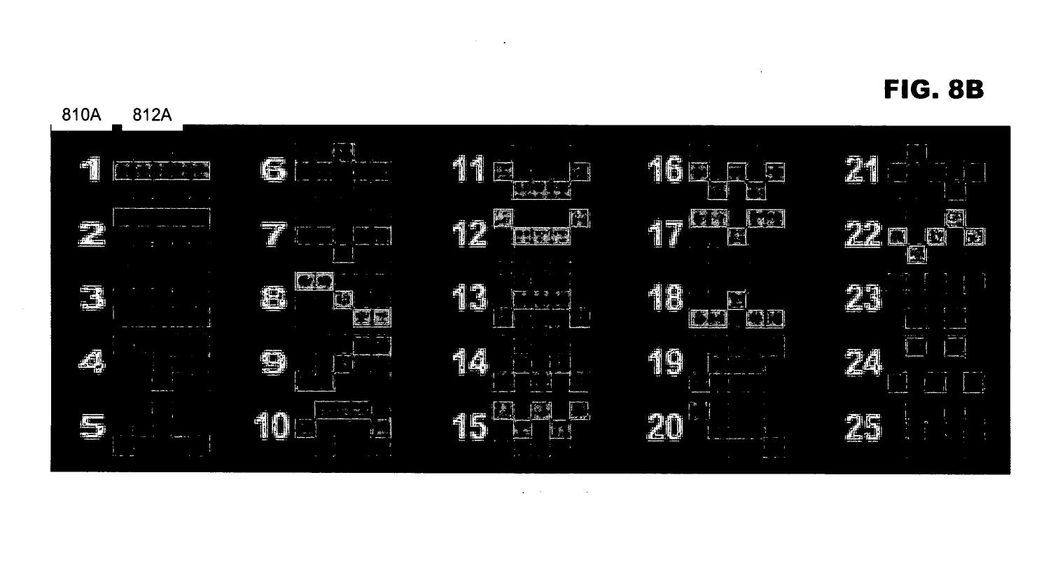

The VGM may award a prize if the symbols end in a pre-defined winning pattern. For example, pre-defined winning patterns may be as depicted in FIG. 8A. Prizes may be anything of value, for example, cash, monetary awards, merchandise, or bonus games. One example prize may be a winning spin bonus. A winning spin bonus may award a quantity of special bonus spins to the player, wherein each winning spin bonus is guaranteed to be a winner. Alternatively, each individual special bonus spin may not be guaranteed to be a winner, but spins continue to be provided to the player until a quantity of winning bonus spins is equal to the award quantity of the winning spin bonus. The VGM will keep providing spins on the virtual reels until it results in a pre-defined winning pattern. The player then receives a prize associated with the pre-defined winning pattern. The quantity of remaining special bonus spins may be decremented. If the quantity of remaining special bonus spins is greater than zero, the VGM begins spinning the virtual reels again, until the player receives the previously awarded quantity of winning special bonus spins.

A credits indicator 104 may indicate a quantity of credits available to the player. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

A cash out button 106 may receive a player indication to cash out the player's credit. For example, the player may cash out his credits when he is finished with his gaming session and wishes to leave the VGM. For example, the credits may be dispensed from the VGM as currency or as a voucher redeemable at a cashier for currency or other prizes. Alternatively, the prize may be dispensed after each play.

A help/pays button 108 may display help screens to the player, including the pay structure and pay lines as depicted in FIGS. 8A and 8B.

A denomination indicator 110 may indicate to the player the denomination of the VGM. The denomination indicator 110 may be prominently displayed to be visible to players browsing past the VGM.

A select lines button 112 may allow the player to select a quantity of lines to be played on the VGM. Each line may be a collection of elements that are checked for a winning pattern of symbols. For example, the lines in the VGM may be as depicted in FIG. 8B. A prize may be awarded on a line if the collection of elements associated with the line display symbols in a pre-defined winning pattern. With multiple lines, the player may have multiple ways to win on one spin of the virtual reels.

In an alternative embodiment, the VGM may award a prize, wherein the prize is dependant on the winning pattern of the symbols and a quantity of lines wagered.

A bet per line button 114 may allow the player to select a bet to be placed on each line. For example, the bet may vary between one credit and a pre-defined maximum quantity of credits acceptable at the VGM.

A max bet spin button 116 may be a shortcut button allowing the player to select the maximum bet available on all selected lines and immediately spin the reels on the VGM. This may save the player time from selecting a bet per line and indicating to the VGM to spin the virtual reels.

The game may be played when the player indicates a quantity of lines to play, a bet amount for each line, and presses the play button 118. The game may proceed by the VGM animating the elements in columns 100A, 100B, 100C, 100D, and 100E to simulate reels in a traditional slot machine. For example, the columns may be animated so it appears the elements are randomly spinning on reels. The animation may finish with the elements in a resulting pattern, where the resulting pattern may be determined randomly, randomly within pre-defined bounds, or in another predetermined manner. The resulting pattern may be a winning pattern or a losing pattern. The VGM may award a prize when a winning pattern occurs and display a consolidation or do nothing when a losing pattern occurs.

A play button 118 may allow the player to spin the virtual reels on the VGM. It will be appreciated that an alternative input device may be used, for the player to indicate their desire to play the game.

The symbols displayed in the elements of FIG. 1A are in a winning pattern 120 which awards the winning spin bonus. The winning pattern 120 includes three mermaid symbols in any three elements. The winning spin bonus is thus triggered.

It will be understood that any pattern of symbols may be pre-defined to award the winning spin bonus.

FIG. 1B illustrates an example screen shot of a transition screen before a bonus game, in accordance with an example embodiment of the present invention. After a winning spin bonus is awarded, the transition screen of FIG. 1B may first be displayed to the player. The transition screen may include a graphics 130, which includes visually attractive patterns that also describe the winning spin bonus. For example, the graphics 130 may describe the quantity of special bonus spins to be awarded. For example, the graphics 130 may also describe a bonus winning multiple, which will be multiplied to all player wins during the winning spin bonus.

A credits indicator 132 may indicate a quantity of credits available to the player. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

FIG. 1C illustrates an example screen shot of a bonus game, in accordance with an example embodiment of the present invention. After a winning spin bonus is awarded and the transition screen of FIG. 1B has been displayed to the player, the winning spin bonus may begin.

The bonus game may provide a game similar to the previous game played on the VGM, such as a simulated slot machine. Alternatively, other forms of bonus games may be provided, such as simulated casino games. For example, roulette, card games, races, etc. The VGM displays a set of elements, each element displaying a symbol. The set of elements may be arranged into columns 140A, 140B, 140C, 140D, and 140E. The set of elements may also be arranged into rows 142A, 142B, and 142C. Each spin of the virtual reels may be a special winning spin. The bonus game may allow a player to play a series of bonus plays, until a quantity of winning plays equal a predetermined of winning plays awarded the player. The number of bonus plays provided need not be fixed. Thus, bonus play may continue until the quantity of winning plays equal a predetermined of winning plays awarded the player.

A credits indicator 144 may indicate a quantity of credits available to the player, similar to the credit indicator depicted in FIG. 1A. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

A denomination indicator 146 may indicate to the player the denomination of the VGM, similar to the denomination indicator depicted in FIG. 1A. The denomination indicator 146 may be prominently displayed to be visible to players browsing past the VGM.

A special bonus spins remaining indicator 148 may indicate to the player the quantity of special winning spins remaining. The special bonus spins remaining indicator 148 may be a counter, decrementing every time a winning spin is made in the game. If the spin is a non-winning spin, the special bonus spins remaining indicator 148 may not be decremented.

FIG. 1D illustrates an example screen shot of a bonus game winning spin, in accordance with an example embodiment of the present invention. After a winning spin bonus is awarded and a special winning spin has been provided by the VGM in FIG. 1C, a winning spin may result.

The winning spin bonus may provide a game similar to the previous game played on the VGM. As described in FIG. 1C, the VGM displays a set of elements, each element displaying a symbol. The set of elements may be arranged into columns 140A, 140B, 140C, 140D, and 140E. The set of elements may also be arranged into rows 142A, 142B, and 142C. Each spin of the virtual reels may be a special winning spin. The winning spin bonus may award a quantity of winning spins and an undetermined quantity of non-winning spins. The difference in the winning spin bonus may be that the VGM continues to spin the virtual reels until the quantity of special winning spins have been awarded.

A credits indicator 144 may indicate a quantity of credits available to the player, similar to the credit indicator depicted in FIG. 1A. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

The credits indicator 144 may be incremented after a winning spin has occurred by amount of an awarded prize, as in FIG. 1D. A winning spin may involve the symbols displayed in the elements resulting in a pre-defined winning pattern, along pre-defined lines. For example, winning patterns may be as depicted in FIG. 8A, while pre-defined lines may be as depicted in FIG. 8B. The amount of the awarded prize may as defined by the pre-defined winning patterns as depicted in FIG. 8A may be multiplied by a winnings multiplier.

A denomination indicator 146 may indicate to the player the denomination of the VGM, similar to the denomination indicator depicted in FIG. 1A. The denomination indicator 146 may be prominently displayed to be visible to players browsing past the VGM.

A special bonus spins remaining indicator 148 may indicate to the player the quantity of special winning spins remaining. The special bonus spins remaining indicator 148 may be a counter, decrementing every time a winning spin is made in the game. If the spin is a non-winning spin, the special bonus spins remaining indicator 148 may not be decremented. As depicted in FIG. 1D, the spin is a winning spin, and therefore the special bonus spins remaining indicator 148 was decremented compared to FIG. 1C.

A prize multiplier indicator 150 may indicate to the player a prize amount of the winning pattern as well as the multiplier for a total prize amount. It is understood that the multiplier may be varied during the special winning spins.

The elements may display symbols which are in a pre-defined winning pattern 152 along a pre-defined line, as depicted in FIGS. 8A and 8B. The prize awarded to the player by the VGM may be determined based on the pre-defined winning pattern and the pre-defined line.

A line indicator 154 may indicate to the player the pre-defined line that was used in determining the winning spin. For example, the pre-defined line may be as depicted in FIG. 8B.

FIG. 1E illustrates an example screen shot of a bonus game non-winning spin, in accordance with an example embodiment of the present invention. After a winning spin bonus is awarded and a special winning spin has been provided by the VGM in FIG. 1C, a non-winning spin may result.

The winning spin bonus may provide a game similar to the previous game played on the VGM. As described in FIG. 1C, the VGM displays a set of elements, each element displaying a symbol. The set of elements may be arranged into columns 140A, 140B, 140C, 140D, and 140E. The set of elements may also be arranged into rows 142A, 142B, and 142C. Each spin of the virtual reels may be a special winning spin. The winning spin bonus may award a quantity of winning spins and an undetermined quantity of non-winning spins. The difference in the winning spin bonus may be that the VGM continues to spin the virtual reels until the quantity of special winning spins have been awarded.

A credits indicator 144 may indicate a quantity of credits available to the player, similar to the credit indicator depicted in FIG. 1A. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

The credits indicator 144 may be left unchanged after a non-winning spin has occurred, as no prize may be awarded on a non-winning spin. A non-winning spin may involve the symbols displayed in the elements not resulting in a pre-defined winning pattern, along pre-defined lines. That is, any pattern that is not a pre-defined winning pattern along pre-defined lines may be a non-winning pattern. For example, pre-defined winning patterns may be as depicted in FIG. 8A, while pre-defined lines may be as depicted in FIG. 8B.

A denomination indicator 146 may indicate to the player the denomination of the VGM, similar to the denomination indicator depicted in FIG. 1A. The denomination indicator 146 may be prominently displayed to be visible to players browsing past the VGM.

A special bonus spins remaining indicator 148 may indicate to the player the quantity of special winning spins remaining. The special bonus spins remaining indicator 148 may be a counter, decrementing every time a winning spin is made in the game. If the spin is a non-winning spin, as in FIG. 1E, the special bonus spins remaining indicator 148 may not be decremented.

When there are no more special bonus spins remaining as indicated by the special bonus spins remaining indicator 148, the bonus game may end and game play may return to the regular game.

A line indicator 154 may indicate to the player the pre-defined line that was used in determining the winning spin. For example, the pre-defined line may be as depicted in FIG. 8B.

FIG. 1F illustrates an example screen shot of a transition screen after a bonus game, in accordance with an example embodiment of the present invention. After the winning spins bonus is over, for example, by awarding a sufficient quantity of winning spins, the transition screen of FIG. 1F may be displayed to the player. The transition screen may include a graphics 156, which includes visually attractive patterns that a congratulatory message. For example, the graphics 156 may describe the quantity of credits awarded to the player.

A credits indicator 132 may indicate a quantity of credits available to the player. For example, credits may be currency in the game, used to purchase wagers. Prizes may also be awarded in credits. Credits may also be counted within the VGM in a base denomination, such as a penny, a nickel, a quarter, a half-dollar, or a dollar. The denomination may be used to describe the VGM, for example, a penny-slot, a nickel-slot, a quarter-slot, a half-dollar-slot, or a dollar-slot.

The credits indicator 132 in FIG. 1F may reflect the prize awarded to the player after the winning spins bonus has been completed.

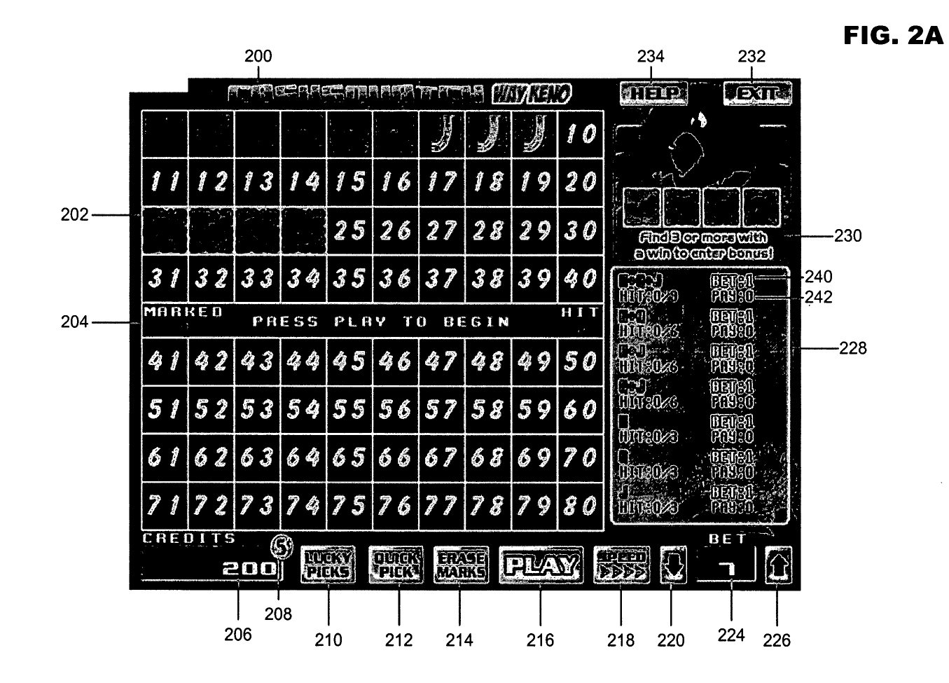

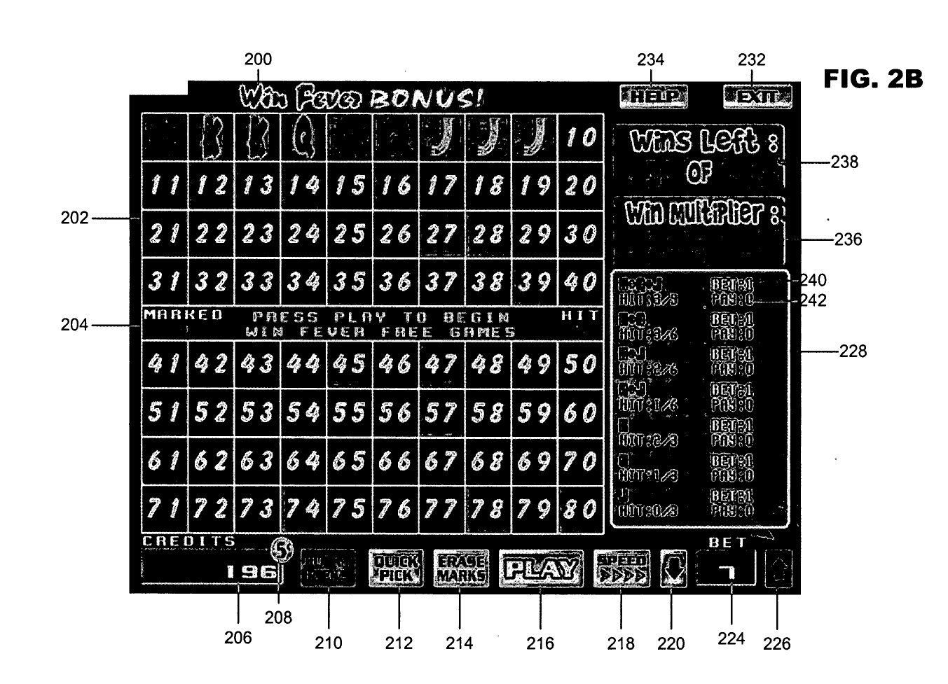

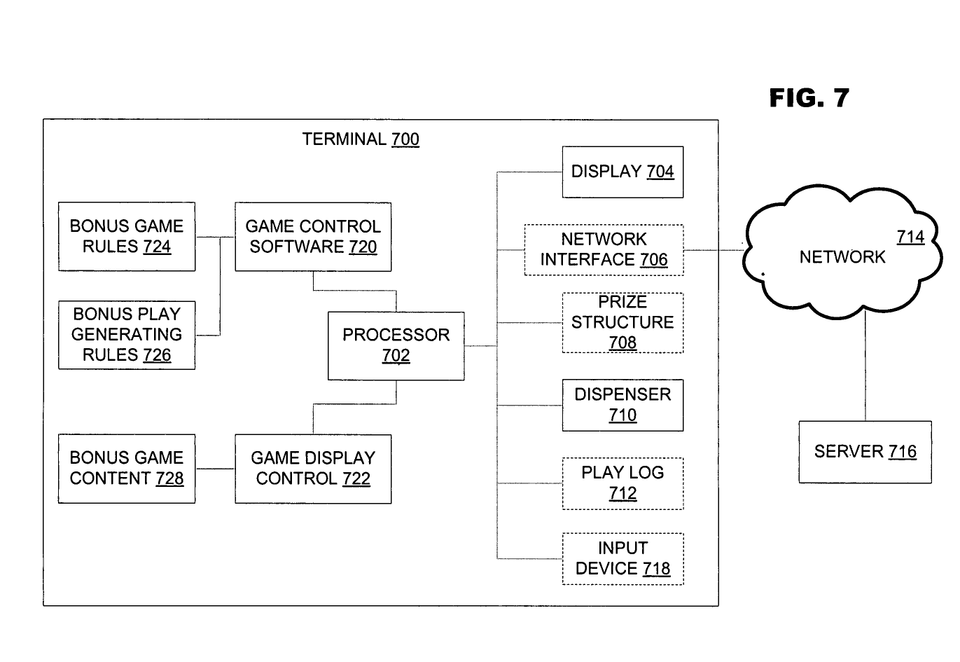

FIG. 2A illustrates an example screen shot of a video keno wagering game, in accordance with an example embodiment of the present invention. The video keno wagering game may be offered on a video gaming machine as depicted in FIG. 6 or on a system as depicted in FIG. 7 to a player.

Title 200 may be a graphic indicating the title of the wagering game and be a visually attractive graphic. Title 200 may include a brand or trademark of the wagering game, as well as information about the operator of the wagering game.

Keno spots 202 may be a plurality of elements selectable by the user. The spots 202 may correspond to the 80 spots used in traditional keno games. The user may select a number of player-selected spots in the wagering game. The player-selected spots may be divided into subgroups for award purposes. For example, certain groups of spots may have higher value if hit in the keno game than others.

As depicted, player-selected spots include “K”, “Q”, “J”, and footprints. The prize awarded may depend on which subset of player-selected spots hit in the keno game.

Information bar 204 may include information such as the number of spots marked by the user, instructions to the user (such as “press play to begin”), and the number of spots hit during a game. A spot may be hit when a player-selected spot is also selected by the wagering game.

A credits indicator 206 may indicate an amount of credits available to the player in the game. The wagering game may take in wagers in credits and award prizes in credits. Credits may accumulate in the wagering game until the player cashes out. Credits may be made available to the player responsive to the player depositing currency in the video gaming machine.

A denomination indicator 208 may indicate a denomination of the video gaming machine. The denomination may be a base amount of a player's wager. For example, in a 5 cent video gaming machine, all wagers may be in 5 cent increments.

A lucky picks button 210 may allow the player to indicate a desire to pick spots normally picked by the machine. For example, a subset of the player-selected spots may be automatically picked by the machine.

A quick picks button 212 may allow the player to indicate a desire to have the video gaming machine pick the player-selected spots. This may speed up the selection process for the player and expedite the start of the game.

An erase marks button 214 may allow the player to erase a previously made mark indicating a player-selected spot. This feature may be available before the game has started and the video gaming machine begin picking winning spots and allow the player to change player-selected spots.

A play button 216 may allow the player to begin play of the game. When the game begins, the video gaming machine may begin selecting winning spots. For example, the video gaming machine may select the winning spots randomly. The process of selecting winning spots may also be known as a random keno draw. The player may win a prize if a predetermined number of player-selected spots match a predetermined number of winning spots.

A speed button 218 may allow the player to increase a speed of the game. For example, the wagering game may provide a high-speed option for when the machine is selecting winning spots. For example, instead of picking and displaying winning spots one at a time, similar to a conventional keno game, all winning spots may be selected and displayed at once. This may reduce player frustration with slow game speed and increase the number of games playable on the video gaming machine.

A bet indicator 224 may indicate the current bet or wager amount for the game. For example, the player may be able to change the wager amount before the game begins. The prize awarded at the end of the game may be determined, in part, on the wager amount.

A decrease bet button 220 and an increase bet button 226 may allow the user to decrease or increase the wager amount before the game begins.

Win information 228 may provide information on how to win a prize in the game. For example, if a predetermined number of player-selected spots marked with “K”, “Q”, and “J” are also selected as winning spots, a prize may be awarded. Different combination of player-selected spots may be used.

Wager information 240 may indicate the wager made by the player on a subset of player-selected spots. The player may place different wagers for different subsets of player-selected spots. As depicted, the player is able to wager on seven subsets of player-selected spots.

Winnings information 242 may indicate the winnings awarded to the player in the current round. Each wager may be associated with a winnings. Winnings information 242 may be updated throughout a round as winning-spots are picked by the machine. As depicted, the player is able to win wagers on seven subsets of player-selected spots.

Bonus information 230 may provide information on how to win a bonus in the wagering game. For example, the player may select four bonus spots. If three of the four bonus spots match the winning spots, the bonus may be awarded.

Exit button 232 may allow the player to exit from a menu or a help screen. The player may also use the exit button to cash out of the game and receive the remaining credits in the game.

Help button 234 may allow the player to access a series of help screens including instructions and other information relevant to playing the wagering game.

FIG. 2B illustrates an example screen shot of a bonus game within a video keno wagering game, in accordance with an example embodiment of the present invention. The video keno wagering game may be offered on a video gaming machine as depicted in FIG. 6 or on a system as depicted in FIG. 7 to a player. A bonus may be provided to the player after a predetermined bonus trigger condition has occurred, for example, three of the four bonus spots selected by the user have been also selected as winning spots in FIG. 2A.

Title 200 may be a graphic indicating the title of the wagering game and be a visually attractive graphic. Title 200 may include a brand or trademark of the wagering game, as well as information about the operator of the wagering game.

Keno spots 202 may be a plurality of elements selectable by the user. The spots 202 may correspond to the 80 spots used in traditional keno games. The user may select a number of player-selected spots in the wagering game. The player-selected spots may be divided into subgroups for award purposes. For example, certain groups of spots may have higher value if hit in the keno game than others.

As depicted, player-selected spots include “K”, “Q”, “J”, and footprints. The prize awarded may depend on which subset of player-selected spots hit in the keno game.

Information bar 204 may include information such as the number of spots marked by the user, instructions to the user (such as “press play to begin”), and the number of spots hit during a game. A spot may be hit when a player-selected spot is also selected by the wagering game.

A credits indicator 206 may indicate an amount of credits available to the player in the game. The wagering game may take in wagers in credits and award prizes in credits. Credits may accumulate in the wagering game until the player cashes out. Credits may be made available to the player responsive to the player depositing currency in the video gaming machine.

A denomination indicator 208 may indicate a denomination of the video gaming machine. The denomination may be a base amount of a player's wager. For example, in a 5 cent video gaming machine, all wagers may be in 5 cent increments.

A lucky picks button 210 may allow the player to indicate a desire to pick spots normally picked by the machine. For example, a subset of the player-selected spots may be automatically picked by the machine.

A quick picks button 212 may allow the player to indicate a desire to have the video gaming machine pick the player-selected spots. This may speed up the selection process for the player and expedite the start of the game.

An erase marks button 214 may allow the player to erase a previously made mark indicating a player-selected spot. This feature may be available before the game has started and the video gaming machine begin picking winning spots and allow the player to change player-selected spots.

A play button 216 may allow the player to begin play of the game. When the game begins, the video gaming machine may begin selecting winning spots. The player may win a prize if a predetermined number of player-selected spots match a predetermined number of winning spots.

A speed button 218 may allow the player to increase a speed of the game. For example, the wagering game may provide a high-speed option for when the machine is selecting winning spots. For example, instead of picking and displaying winning spots one at a time, similar to a conventional keno game, all winning spots may be selected and displayed at once. This may reduce player frustration with slow game speed and increase the number of games playable on the video gaming machine.

The increased speed feature may be important during the bonus game, where bonus games are repeatedly offered to the player until a number of winning games have been provided.

A bet indicator 224 may indicate the current bet or wager amount for the game. For example, the player may be able to change the wager amount before the game begins. The prize awarded at the end of the game may be determined, in part, on the wager amount.

A decrease bet button 220 and an increase bet button 226 may allow the user to decrease or increase the wager amount before the game begins.

Win information 228 may provide information on how to win a prize in the game. For example, if a predetermined number of player-selected spots marked with “K”, “Q”, and “J” are also selected as winning spots, a prize may be awarded. Different combination of player-selected spots may be used.

Wager information 240 may indicate the wager made by the player on a subset of player-selected spots. The player may place different wagers for different subsets of player-selected spots. As depicted, the player is able to wager on seven subsets of player-selected spots.

Winnings information 242 may indicate the winnings awarded to the player in the current round. Each wager may be associated with a winnings. Winnings information 242 may be updated throughout a round as winning-spots are picked by the machine. As depicted, the player is able to win wagers on seven subsets of player-selected spots.

Exit button 232 may allow the player to exit from a menu or a help screen. The player may also use the exit button to cash out of the game and receive the remaining credits in the game.

Help button 234 may allow the player to access a series of help screens including instructions and other information relevant to playing the wagering game.

A win multiplier indicator 236 may indicate a multiplier by which all winnings in the bonus game are multiplied by before providing a prize.

A wins left indicator 238 may indicate the number of winning games remaining before the bonus is over. If a bonus game is a winning game and a prize is awarded, the wins left indicator 238 may be decremented. If a bonus game is not a winning game and no prize is awarded, the wins left indicator may be unchanged.

When there are no wins left as indicated by the wins left indicator 238, the bonus game may end and game play may return to the regular game.

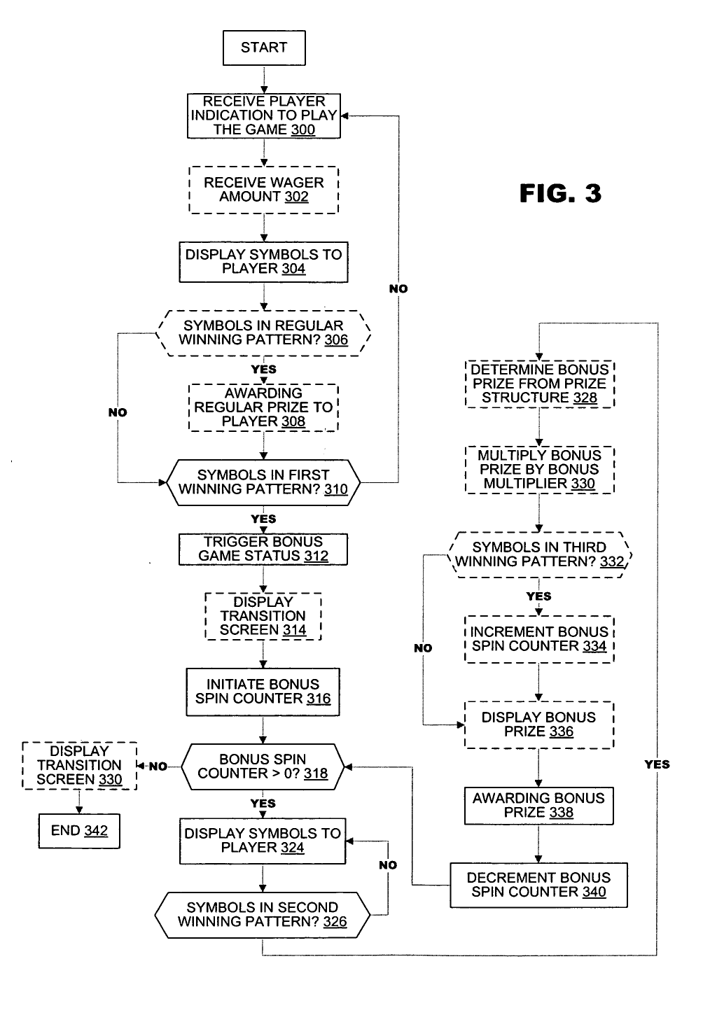

FIG. 3 illustrates a first example procedure for providing a wagering game, in accordance with an example embodiment of the present invention. The procedure may be configured to execute on a VGM as depicted in FIG. 6 and provide a virtual slot machine game to a player.

For example, the wagering game may be a video slot machine. In an alternative embodiment, the wagering game may be a video poker game, a video bingo game, a video keno game, or any other wagering game configured to execute on a video gaming machine.

In 300, the procedure may receive a player indication of a desire to play the virtual slot machine game. For example, the player may indicate by inputting on an input device or by submitting an amount of currency.

In 302, the procedure may optionally receive a wager amount from the player. For example, the wager amount may be an amount of currency to be wagered by the player on a spin of the virtual reels. The prize to be awarded may, in part, be determined based on the wager amount.

In an alternative embodiment, the procedure may receive the wager amount in 300 at the same time as receiving the player indication.

In 304, the procedure may display symbols to the player. For example, symbols may be displayed in elements on a display of the VGM. The symbols may be animated to simulated spinning slot machine reels before the symbols are displayed to the player.

In 306, the procedure may optionally test whether the symbols are in a regular winning pattern. For example, the regular winning pattern may be a pre-defined winning pattern for a regular win. A regular win may award a regular prize. If yes, the procedure may proceed to 308. If no, the procedure may skip to 310.

In 308, the procedure may optionally award a prize to the player. The prize may be a regular prize. For example, the regular prize may be a prize such as currency, merchandise, or some other valuable consideration.

In 310, the procedure may test whether the symbols are arranged in a first winning pattern. For example, the first winning pattern may be a pre-defined pattern that triggers a winning spins bonus, which can also be indicated within the game by a bonus game status. The first winning pattern may be as depicted in FIG. 1A.

For example, the winning spins bonus may include special winning spins as depicted in FIGS. 1A, 1B, 1C, 1D, 1E, and 1F. A quantity of special winning spins may be awarded, and the VGM keeps providing virtual spins until a quantity of winning spins have been providing, the quantity of winning spins matching the quantity of special winning spins awarded.

If the symbols are arranged in a first winning pattern, the procedure may proceed to 312. If not, the procedure may return to 300. From 300, the procedure may default to a last wager amount for the wager amount of the current spin. That is, the wager amount may be set to the wager amount of the last virtual spin, where the player has an option to change the wager amount if desired.

In 312, the procedure may trigger a bonus game status, which may also be a winning spins bonus. This may begin a winning spins bonus.

In 314, the procedure may optionally display a transition screen, as depicted in FIG. 1B.

In 316, the procedure may initiate a bonus spin counter. For example, the bonus spin counter may be an integer counter in the VGM which keeps track of a quantity of winning spins awarded to the player. The bonus spin counter may be initiated to an integer greater than 0, for example, 5.

In 318, the procedure may test whether the bonus spin counter is greater than zero. If yes, the procedure may continue to 324. When the counter is zero, no more special winning spins are to be provided to the player, and the procedure may begin an end sequence. If no, the procedure may proceed to 330 and provide special winning spins.

In an alternative embodiment, no counter is used. For example, the procedure may utilize a flag instead.

In 330, the procedure may optionally display a transition screen after the end of the winning spins bonus. For example, the transition screen may be as depicted in FIG. 1F. After the transition screen is displayed, the VGM may display a screen shot of the winning spins bonus game, as depicted in FIG. 1C.

In 342, the procedure may end.

In 334, the procedure may procedure may provide a virtual spin and display symbols to the player. This may be similar to 304, except the game may be in a winning spins bonus mode and thus providing special winning spins.

In 326, the procedure may test whether the symbols are in a second winning pattern. The second winning pattern may be a pre-defined winning pattern that awards a bonus award as a winning spin. For example, the VGM may provide a winning spin screen shot as depicted in FIG. 1D.

It is understood that there may be a plurality of winning patterns that provide a bonus award, similar to how a plurality of winning patterns may provide a regular award.

If yes, the procedure may proceed to 328. If no, the procedure may return to 334 where another virtual spin is provided to the player. If no, the VGM may have displayed a non-winning spin. A non-winning spin may be as depicted in FIG. 1E.

In 328, the procedure may optionally determine a bonus prize from a prize structure. For example, the prize structure may be as depicted in FIGS. 8A and 8B, wherein the pre-defined pay lines are used in conjunction with the prize structure to determine the bonus prize.

In 330, the procedure may optionally multiply the bonus prize by a bonus multiplier. For example, the bonus multiplier may be a multiplier used to multiply all prizes calculated in 328 to determine the bonus prize awarded. It is understood that the bonus multiplier may be a variable quantity, for example, increasing or decreasing after each winning spin.

In 332, the procedure may optionally test whether the symbols are in a third pre-defined winning pattern. For example, the third pre-defined winning pattern may be a winning pattern that awards additional special winning spins in the winning spins bonus. If yes, the procedure may proceed to 334. If no, the procedure may proceed to 336.

In 334, the procedure may optionally increment the quantity of special winning spins to the player by incrementing the bonus spin counter.

In 336, the procedure may optionally display the bonus prize. For example, the bonus prize may be displayed on the VGM, as depicted in FIG. 1D, where the total win is displayed to the player.

In 338, the procedure may award the bonus prize. For example, the bonus prize may be added to a cumulative prize for bonus prizes awarded to the player during the winning spins bonus. The cumulative prize may be paid out at the end of the winning spins bonus.

In 340, the procedure may decrement the bonus spin counter. The procedure may then proceed to 318.

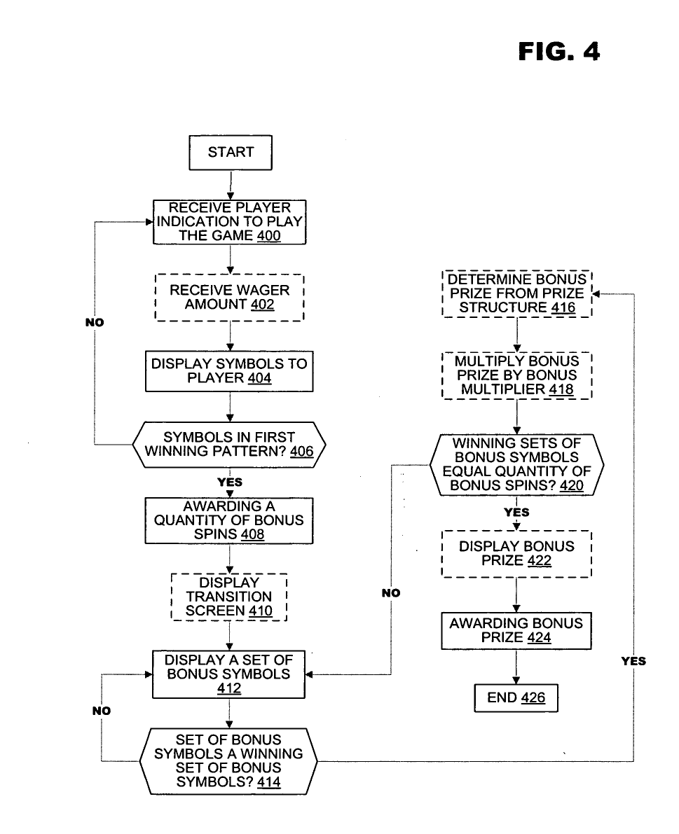

FIG. 4 illustrates a second example procedure for providing a wagering game, in accordance with an example embodiment of the present invention. The procedure may be configured to execute on a VGM as depicted in FIG. 6 and provide a virtual slot machine game to a player.

In 400, the procedure may receive a player indication to participate in the wagering game. For example, the player may indicate by inputting on an input device or by submitting an amount of currency.

In 402, the procedure may optionally receive a wager amount from the player. For example, the wager amount may be an amount of currency to be wagered by the player on a spin of the virtual reels. The prize to be awarded may, in part, be determined based on the wager amount.

In an alternative embodiment, the procedure may receive the wager amount in 200 at the same time as receiving the player indication.

In 404, the procedure may display symbols to the player. For example, symbols may be displayed in elements on a display of the VGM. The symbols may be animated to simulated spinning slot machine reels before the symbols are displayed to the player.

In 406, the procedure may test whether the symbols are in a first winning pattern. For example, the first winning pattern may be a pre-defined pattern that triggers a winning spins bonus, which can also be indicated within the game by a bonus game status. The first winning pattern may be as depicted in FIG. 1A.

For example, the winning spins bonus may include special winning spins as depicted in FIGS. 1A, 1B, 1C, 1D, 1E, and 1F. A quantity of special winning spins may be awarded, and the VGM keeps providing virtual spins until a quantity of winning spins have been providing, the quantity of winning spins matching the quantity of special winning spins awarded.

If yes, the procedure may proceed to 408. If no, the procedure may return to 400. From 400, the procedure may default to a last wager amount for the wager amount of the current spin. That is, the wager amount may be set to the wager amount of the last virtual spin, where the player has an option to change the wager amount if desired.

In 408, the procedure may award a quantity of bonus spins to the player. For example, the winning spins bonus may award a pre-defined quantity of winning spins to be provided as special winning spins.

In 410, the procedure may display a transition screen, as depicted in FIG. 1B.

In 412, the procedure may display a set of bonus symbols. The VGM may provide virtual spin and display symbols to the player. This may be similar to 404, except the game may be in a winning spins bonus mode and thus providing special winning spins.

In 414, the procedure may test whether the set of bonus symbols are a winning set of symbols. The winning set of symbols may be a pre-defined winning pattern that awards a bonus award as a winning spin. For example, the VGM may provide a winning spin screen shot as depicted in FIG. 1D.

It is understood that there may be a plurality of winning patterns that provide a bonus award, similar to how a plurality of winning patterns may provide a regular award.

If yes, the procedure may proceed to 416. If no, the procedure may return to 412 where another virtual spin is provided to the player. If no, the VGM may have displayed a non-winning spin. A non-winning spin may be as depicted in FIG. 1E.

In 416, the procedure may determine a bonus prize from a prize structure. For example, the prize structure may be as depicted in FIGS. 8A and 8B, wherein the pre-defined pay lines are used in conjunction with the prize structure to determine the bonus prize.

In 418, the procedure may multiply the bonus prize by a bonus multiplier. For example, the bonus multiplier may be a multiplier used to multiply all prizes calculated in 228 to determine the bonus prize awarded. It is understood that the bonus multiplier may be a variable quantity, for example, increasing or decreasing after each winning spin.

In 420, the procedure may test whether the winning sets of bonus symbols equal a quantity of bonus spins.

In 422, the procedure may display a bonus prize. For example, the bonus prize may be displayed on the VGM, as depicted in FIG. 1D, where the total win is displayed to the player.

In 424, the procedure may award a bonus prize. For example, the bonus prize may be added to a cumulative prize for bonus prizes awarded to the player during the winning spins bonus. The cumulative prize may be paid out at the end of the winning spins bonus.

In 426, the procedure may end.

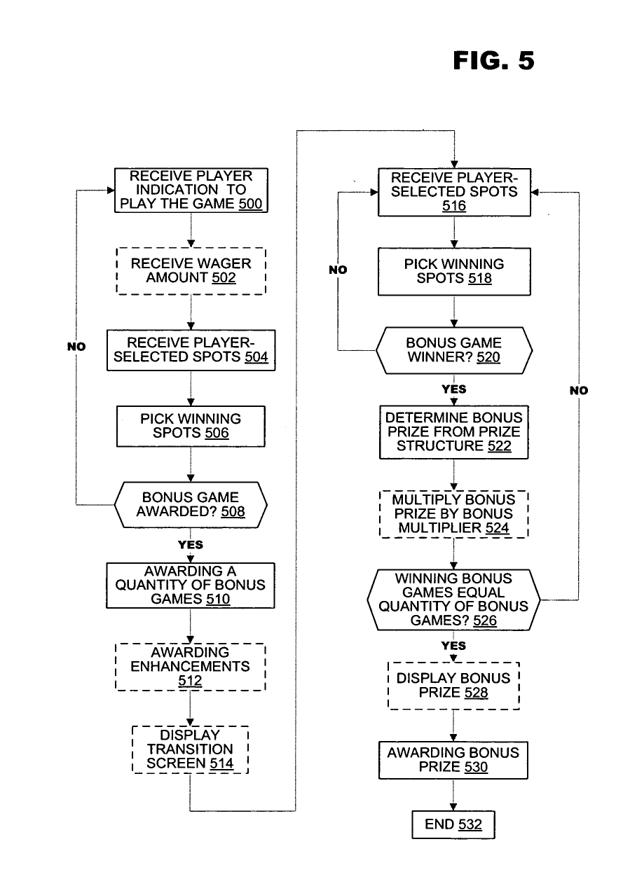

FIG. 5 illustrates an example procedure for providing a video keno wagering game, in accordance with an example embodiment of the present invention. The procedure may be configured to execute on a VGM as depicted in FIG. 6 and provide a virtual slot machine game to a player.

In 500, the procedure may receive a player indication to participate in the wagering game. For example, the player may indicate by inputting on an input device or by submitting an amount of currency.

In 502, the procedure may optionally receive a wager amount from the player. For example, the wager amount may be an amount of currency to be wagered by the player in a video keno game. The prize to be awarded may, in part, be determined based on the wager amount.

In an alternative embodiment, the procedure may receive the wager amount in 500 at the same time as receiving the player indication.

In 504, the procedure may receive player-selected spots from the player. For example, player-selected spots may be divided into subset, with different combinations of subsets awarding different prizes. The player-selected spots may be selected from the 80 spots available in the video keno game.

In 506, the procedure may select winning spots in the video keno game. For example, 20 spots may be selected as winning spots. The prize to be awarded the player may be determined, in part, based on the number of player-selected spots received in 504 that match winning spots.

In 508, the procedure may test whether a bonus trigger condition has been met. For example, a bonus trigger condition may be a subset of the player-selected spots matches the winning spots. The subset of player-selected spots may be bonus spots.

If yes, the procedure may proceed to 510. If no, the procedure may return to 500. From 500, the procedure may default to a last wager amount for the wager amount of the game. That is, the wager amount may be set to the wager amount of the last game, where the player has an option to change the wager amount if desired.

In 510, the procedure may award a quantity of bonus games to the player. For example, the bonus triggering condition may award a pre-defined quantity of winning games to be provided as special winning games. One bonus triggering condition may be three of four bonus spots were selected as winning spots. Another bonus triggering condition may be four of four bonus spots were selected as winning spots.

In 512, the procedure may optionally award bonus enhancements. Bonus enhancements may be awarded if certain bonus triggering conditions are met. For example, bonus enhancements may be additional winning spots drawn in the bonus game, additional bonus games in addition to the quantity awarded in 510, a bet multiplier that increases the wager amount received in 502, and a win multiplier.

In 514, the procedure may optionally display a transition screen.

In 516, the procedure may receive player-selected bonus spots from the player. For example, player-selected bonus spots may be divided into subset, with different combinations of subsets awarding different prizes. The player-selected bonus spots may be selected from the 80 spots available in the video keno game.

In an alternative embodiment, the player-selected bonus spots may be the same as the player-selected spots received in 504.

In 518, the procedure may select bonus winning spots in the video keno game. For example, 20 spots may be selected as bonus winning spots. The bonus prize to be awarded the player may be determined, in part, based on the number of player-selected bonus spots received in 504 that match the bonus winning spots.

In 520, the procedure may test whether the bonus game is a winner. For example, the bonus game may be a winner if a predetermined number of player-selected bonus spots are also selected as bonus winning spots.

If yes, the procedure may proceed to 522. If no, the procedure may return to 516 where another set of player-selected bonus spots are received. In an alternative embodiment, the procedure may proceed to 518 and another set of bonus winning spots are picked by the procedure. In this alternative embodiment, the player may not change the player-selected bonus spots after the bonus game has started.

In 522, the procedure may determine a bonus prize from a prize structure. For example, the prize structure may relate a number of player-selected bonus spots and special subsets of player-selected bonus spots and the winning bonus spots with corresponding prizes.

In 524, the procedure may multiply the bonus prize by a bonus multiplier. For example, the bonus multiplier may be a multiplier used to multiply all prizes calculated in 522 to determine the bonus prize awarded. It is understood that the bonus multiplier may be a variable quantity, for example, increasing or decreasing after each winning spin. For example, the bonus multiplier may be as determined in 512.

In 526, the procedure may test whether the winning games equal a quantity of games awarded. For example, the quantity of games awarded may be equal to the quantity awarded in 510.

In 528, the procedure may optionally display a bonus prize. For example, the bonus prize may be displayed on the VGM where the total win is displayed to the player.

In 530, the procedure may award the bonus prize. For example, the bonus prize may be added to a cumulative prize for bonus prizes awarded to the player during the winning bonus game. The cumulative prize may be paid out at the end of the game.

In 532, the procedure may end.

FIG. 6 illustrates an example video gaming machine (VGM), in accordance with an example embodiment of the present invention. A video gaming machine 610 may be configured to conduct a wagering game. For example, a wagering game may be a slot machine game, a lottery, a video game, or another game of chance involving a wager. For example, the video gaming machine 610 may be a video poker game terminal, a video wagering game terminal, a video slot machine, or a video game terminal. The video gaming machine 610 may be in communication with a server. Alternatively, the video gaming machine 610 may be a standard slot machine terminal.

The video gaming machine 610 may include a blinker 612. The blinker 612 may enclose a light source configured to blink on and off. For example, the blinker 612 may be configured to blink when a large prize is awarded from the video gaming machine 610.

The video gaming machine 610 may include a lighted display 614. For example, the lighted display 614 may include a logo, a game name or other visually attractive graphics. The lighted display 614 may alternatively be a liquid crystal display screen. For example, the lighted display 614 may be configured to display graphics and text.

The video gaming machine 610 may include a display screen 616. For example, the display screen 616 may be a liquid crystal display screen (LCD) or a cathode ray tube (CRT) screen. For example, the display screen 616 may enclose a viewable display area visible to a player. Alternatively, the display screen 616 may be a touch screen, configured to accept player inputs of touching the screen.

The video gaming machine 610 may include a player's card accepter 618, a printer 620 and a currency accepter 632. For example, the player's card accepter 618 may accept a frequent player's card. The frequent player's card may include a player's identifying information and play history. Alternatively, the frequent player's card may include an identifier that is associated with a player's identifying information and wager history. For example, the printer 620 may be configured to print a voucher or ticket for the player. The currency accepter 632 may be configured to accept cash bills in various denominations for a player's wager. The currency accepter 632 may also be configured to accept printed vouchers and tickets.

The video gaming machine 610 may include input modules 622. For example, the input modules 622 may be a set of buttons. The input modules 622 may be configured to receive input from a player during a wagering game. Other forms of input modules may be used, for example, a mouse-pointer device or a voice recognition module.

The video gaming machine 610 may include a dispenser tray 624 and a dispenser 626. The dispenser 626 may be configured to dispense a prize. For example, a prize may be currency or a prize receipt redeemable at a cashier. The dispenser tray 624 may be configured to catch the prize after it is dispensed.

The video gaming machine 610 may include openings 628, 634 and 636. The opening 628 may be configured to allow ambient air to circulate into and out of an interior of the video gaming machine 610. Ambient air circulation may assist in maintaining an optimal operating temperature for the video gaming machine 610. Openings 634 and 636 may be configured to allow sound through. For example, interior speakers may be located behind openings 634 and 636.

The video game machine 610 may include a latch 630. For example, the latch 630 may be configured to release a front door of the video game machine 610 for opening. When the front door is opened, it may be possible for a technician to access an interior of the video game machine 610 for upgrades or maintenance.

FIG. 7 illustrates an example system for providing a wagering game, in accordance with an example embodiment of the present invention. For example, the system may include a terminal 700 which may be a VGM as depicted in FIG. 6. The VGM may be configured to provide a virtual slot machine game as described in FIGS. 1A, 1B, 1C, 1D, 1E, and 1F to a player. The VGM may be configured to execute the procedures depicted in FIGS. 2, 3, and 4.

The terminal 700 may include a processor 702. The processor 702 may be configured to execute the procedures depicted in FIGS. 2, 3, and 4. The processor 702 may be configured to provide screen shots as depicted in FIGS. 1A, 1B, 1C, 1D, 1E, and 1F to a display 704.

The terminal 700 may include a display 704. The display 704 may be configured to display the screen shots as depicted in FIGS. 1A, 1B, 1C, 1D, 1E, and 1F. The display 704

The terminal 700 may optionally include a network interface 706. The network interface 706 may be configured to communicate between the terminal 700 and a network. For example, the network interface 706 may be an Ethernet adaptor, a modem, or some other communication adaptor for converting information from the processor 702 into a form that can be carried over a communications network.

The terminal 700 may optionally include a prize structure 708. The prize structure 708 may include the prizes awarded in the game as well as winning patterns associated with each prize. For example, the prize structure 708 may include symbols that must be displayed in the elements on the VGM's display, as well as how they are arranged along pre-defined lines. For example, the prize structure 708 may include information depicted in FIGS. 8A and 8B.

The terminal 700 may include a dispenser 710. The dispenser 710 may award the player's prize when the player elects to cash out of the game. The dispenser 710 may be configured to dispense currency, such as coins, to award the prize.

Alternatively, the dispenser 710 may be a printer configured to print a voucher redeemable at a cashier for the prize.

Alternatively, the dispenser 710 may be configured to dispense merchandise or other physical goods as the prize. Alternatively, the dispenser 710 may be configured to dispense any suitable prize.

The terminal 700 may optionally include a play log 712. The play log 712 may be a log maintained by the terminal 700 of transactions. For example, transactions may include wagers provided to the terminal 700, prizes dispensed by the terminal 700, winning and non-winning spin results, a bet amount, selected pre-defined lines, a date and time of a virtual wheel spin, a frequent player identification, or any other information pertaining to the operation of the terminal 700.

For example, the information may be used for maintenance or audit purposes by the operator of the terminal 700. The terminal 700 may require maintenance after a pre-defined quantity of virtual spins or a pre-defined quantity or amount of prizes awarded. The operator of the terminal 700 may review the information to audit the performance of the game, for example, by checking for unusual patterns of prizes being awarded.

The terminal 700 may include an input device 718, such as a keypad, buttons, pointing device, scrolling wheels, or other conventional input devices. The input device 718 may be configured to receive inputs from the player required during the game.

It is understood that the terminal 700 may include more than one input device, though only one is depicted.

In an alternative embodiment, the display 704 may be a touch-sensitive screen which receives user inputs via the user touching the screen on displayed virtual buttons. In this example embodiment, an input device 718 may not be required.

The terminal 700 may include a game control software 720, which is accessible to the processor 702. The game control software 720 may be configured to control the wagering game offered at the terminal 700.

The terminal 700 may include a game display control 722, which is accessible to the processor 702. The game display control 722 may be configured to the display 704.

The terminal 700 may include a bonus game rules 724, which is accessible to the processor 702. The bonus game rules 724 may be configured to control the bonus game, if awarded to the player.

The terminal 700 may include a bonus play generating rules 726, which is accessible to the processor 702. The bonus play generating rules 726 may be configured to control play of the bonus game, if awarded to the player.

The terminal 700 may include a bonus game content 728, which is accessible to the processor 702. The bonus game content 728 may be configured to provide content for the bonus game, if awarded to the player.

The terminal 700 may be in communication with a server 716 over a network 714. The network 714 may be any communications link that may carry communications between the terminal 700 and the server 716. For example, the network 714 may be an Ethernet network, a local area network, a wide area network, a virtual private network over another network, the Internet, or any other network which can carry communications.

The server 716 may be a central server located at a location remote from the terminal 700. The server 716 may coordinate a plurality of terminals (not depicted) in the system distributed at multiple locations. The server 716 may function to centralize control of the terminals.

It will be understood that functionality included in the terminal 700 may be moved to the server 716 while remaining within the scope of this specification.

It will be understood that the system may be a standalone terminal, without the network 714 or the server 716. A standalone terminal may be used when establishing a communication connection over a network to a server is cost-prohibitive or otherwise undesirable.

It will be understood that the system may include a payment acceptor. For example, the payment acceptor may be configured to accept cash, credit cards, debit cards, proprietary magnetic cards, vouchers, or other forms of payment.

FIG. 8A illustrates an example pay structure, in accordance with an example embodiment of the present invention. For example, the pay structure may be used in part to determine the prize awarded to a player in a virtual slot machine game. The prize may be further determined based on the player's wager amount. The prize may be awarded when a specified quantity of specific symbols appear on a pre-defined line. For example, pre-defined lines may be as depicted in FIG. 8B.

The pay structure may include symbols 800A, 800B, 800C, 800D, 800E, 800F, 800G, 800H, 8001, 800J, and 800K. For example, the symbols may be displayed in elements on a display in a VGM.

Each symbol may be associated with a prize amount. The prize amount may be a multiplier used to multiply by the player's wager amount to determine the prize to be awarded. For example, the symbol 800A may be associated prize amounts 802A, 802B, 802C, and 802D.

The prize amount 802A may be used when the virtual spin results in 5 of the symbol 800A along a pre-defined line. The prize amount 802B may be used when the virtual spin results in 5 of the symbol 800A along a pre-defined line. The prize amount 802C may be used when the virtual spin results in 5 of the symbol 800A along a pre-defined line. The prize amount 802D may be used when the virtual spin results in 5 of the symbol 800A along a pre-defined line.

The pay structure may be stored in the VGM in a variety of data structures, for example, on write-once memory.

FIG. 8B illustrates an example pay line structure, in accordance with an example embodiment of the present invention. The pay line 812A may be pre-defined and used in conjunction with the pay structure depicted in FIG. 8A to determine a prize to be awarded a player in a virtual slot machine game played on a VGM. Each pay line 812A may be associated with a pay line identifier 810A.

The pre-defined pay lines may be stored in the VGM in a variety of data structures, for example, on write-once memory.

It will be appreciated that an alternative embodiment is a standard mechanical slot machine with the bonus game feature. The machine may be configured to award a predetermined quantity of winning bonus spins, and bonus spins are provided to the player until a quantity of winning bonus spins is equal to the awarded quantity of predetermined winning bonus spins.

### Modifications

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

1. A system for facilitating play of a game of chance, comprising:
an input device configured to receive a player indication of a desire to play the game;
a display configured to
display a set of game elements simulating slot machine reels responsive to the player indication, and
display a bonus game display responsive to a pre-defined bonus condition in the set of game elements, the bonus game comprising a series of bonus game plays that are provided until a predetermined quantity of bonus game play wins have occurred in the bonus game; and
a processor in communication with the input device and the display, the processor configured to
determine the set of game elements based on pre-defined rules responsive to the player indication, and
determine the series of bonus game plays that are provided responsive to the occurrence of the pre-defined bonus condition in the set of game elements, the series of bonus games being provided until the predetermined quantity of bonus game wins occurs in the bonus game play.

2. The system of claim 1, further comprising a dispenser for dispensing a prize to the player, the prize based at least in part on the series of bonus game plays.

3. The system of claim 2, further comprising:
a prize structure, the prize structure mapping a pre-defined winning pattern to the prize associated with the pre-defined winning pattern.

4. The system of claim 2, wherein the prize is determined by multiplying the prize by a bonus multiplier.

5. The system of claim 1, further comprising:
a payment receiving device to receive a payment from the player prior to the display displaying the set of game elements, the payment receiving device communicating to the processor that payment has been received.

6. The system of claim 1, wherein bonus game plays are simulated slot machine reel spins.

7. The system of claim 1, wherein individual bonus game plays are not guaranteed wins.

8. The system of claim 1, wherein the processor is configured to determine the predetermined quantity of bonus game wins based on the pre-defined bonus condition.

9. The system of claim 1, wherein the display is configured to signal the player the predetermined quantity of bonus game wins that have been awarded.

10. The system of claim 1, wherein the display is further configured to display a transition screen before displaying the bonus game display.

11. The system of claim 1, further comprising:
a network interface in communication with a server over a network.

12. A method for facilitating play of a game of chance, comprising:
responsive to a player indication of a desire to play the game, displaying a set of game elements to the player, wherein the set of game elements simulate slot machine reels; and
responsive to an occurrence of a pre-defined trigger condition, providing a bonus game to the player, the bonus game comprising a series of bonus game plays that are provided until at least a pre-defined quantity of bonus game wins have occurred.

13. The method of claim 12, wherein the pre-defined trigger condition is a pre-defined winning pattern in the set of game elements.

14. The method of claim 12, wherein the bonus game plays are simulated slot machine reel spins.

15. The method of claim 12, wherein the individual bonus game plays are not guaranteed to win.

16. The method of claim 12, wherein the pre-defined quantity of bonus game wins is based on the pre-defined trigger condition.

17. The method of claim 12, further comprising:
responsive to the completion of the pre-defined quantity of bonus game wins, returning to a normal game play.

18. The method of claim 12, further comprising:
awarding a bonus prize to the player for each bonus game win, wherein each bonus prize is determined by looking up a prize structure and determining the bonus prize corresponding to the bonus game win. The method of claim 18, further comprising:
receiving a wager amount from the player, wherein the bonus award is further determined in part based on the wager amount.

19. A method for facilitating play of a game of chance, comprising:
responsive to a player indication of a desire to play the game, displaying a set of game elements to the player, wherein the set of game elements simulate slot machine reels;
awarding a quantity of winning bonus spin to the player if the set of game elements are in a first pre-defined winning pattern;
sequentially displaying at least one set of bonus elements to the player, including a subset of winning sets of bonus elements wherein a quantity of winning sets of bonus elements is equal to the quantity of winning bonus spins awarded; and
awarding a prize associated with the winning sets of bonus elements.

20. The method of claim 19, wherein the sets of bonus elements is not equal to the subset of winning sets of bonus elements.

21. The method of claim 19, wherein the prize associated with each winning set of bonus elements is determined by looking up a prize structure.

22. The method of claim 19, wherein the prize is determined by multiplying an award by a bonus multiplier.

23. The method of claim 19, further comprising:
displaying a total amount of prizes awarded while displaying the quantity of sets of bonus elements.

24. The method of claim 19, further comprising:
displaying a transition screen after the bonus spins are awarded.

25. The method of claim 19, further comprising:
receiving a wager amount from the player, wherein the prize is further determined in part based on the wager amount.

26. A method for facilitating play of a game of chance, comprising:
responsive to a player indication of a desire to play the game, displaying a set of game elements to the player; and
responsive to an occurrence of a pre-defined trigger condition, providing a bonus game to the player, the bonus game comprising a series of bonus game plays that are provided until at least a pre-defined quantity of bonus game wins have occurred.

27. The method of claim 26, wherein the game of chance is a keno game.

28. The method of claim 26, wherein the game of chance is a poker game.

29. The method of claim 26, wherein the game of chance is a roulette game.

30. The method of claim 26, wherein the game of chance is a bingo game.

31. The method of claim 26, wherein the pre-defined trigger condition is a pre-defined number of player-selected spots matching a second pre-defined number of winning spots.

32. The method of claim 26, further comprising:
receiving player-selected elements in the game of chance.

33. The method of claim 26, further comprising:
awarding a bonus prize to the player responsive to providing the pre-defined quantity of bonus game wins.

34. The method of claim 26, further comprising:
awarding a regular prize to the player responsive to the set of game elements.
